(19) United States
(12) Patent Application Publication
(10) Pub. No.: US 2007/0154606 A1
(43) Pub. Date: Jul. 5, 2007

(54) Method for heat treating a food product emulsion and device for heat treating a food product

(75) Inventors: Abdul Sultanovich Kurkaev, Alma-Aty (KZ); Isa Sultanovich Kurkaev, Alma-Aty (KZ); Georgy Konstantinovich Manastyrly, St. Petersburg (RU); Elena Antonovna Alieva, St. Petersburg (RU); Natalya Vasillevna Logvina, St. Petersburg (RU)

Correspondence Address: HOUSTON ELISEEVA, 4 MILITIA DRIVE, SUITE 4, LEXINGTON, MA, 02421, US

(73) Assignee: ABDUL SULTANOVICH KURKAEV ISA SULTANOVICH KURKAEV, ALMA-ATY (KZ)

(21) Appl. No.: 10/543,711

(22) PCT Filed: Jan. 29, 2004
(86) PCT No.: PCT/RU04/00038

§ 371 Date: Sep. 25, 2006

(30) Foreign Application Priority Data
Jan. 30, 2003 (RU) 2003102487

(51) Int. Cl. A23P 1/00; A01J 25/00; A23B 4/052

(52) U.S. Cl. 426/519; 99/352

(57) ABSTRACT

The inventive method for treating a food product emulsion during the production thereof comprises supplying said emulsion under pressure to a heat-exchange device, whose housing (1) walls are provided with an internal cylindrical cooling surface, in performing a continuous mechanical action on the emulsion and in moving it with the aid of a rotatable shaft (2). The product is displaced at a speed ranging from 750 to 1440 revolutions per minute. A constant temperature of the internal cooling surface of the walls is maintained by means of a thermoelectrical battery (4) whose cold junctions are arranged on the external surface of the housing (1), said surface being provided with flat faces where said cold junctions are arranged. Heat power of 2.5-5.0 W/cm² is supplied to said thermoelectrical battery from an external current supply unit. Said invention is characterised in that a uniform cooling of the product is ensured by the defined displacement speed of the shaft, the transport/displacement speed of the product and by said thermoelectric battery arranged on the flat faces of the body of the heat exchange device. The invention also increases the performance and operating reliability of the device, the ecological safety and energy efficiency thereof.

### RELATED APPLICATIONS

This application is a National Stage of PCT application serial number PCT/RU04/000038 filed on Jan. 29, 2004 which in turn claims priority to Russian application serial number RU2003102487 filed on Jan. 30, 2003, both of which are incorporated herein by reference in their entirety.

### FIELD OF THE INVENTION

This invention is intended for beat processing of food products and can be used in the technological equipment for heat processing in the food and processing industries.

### BACKGROUND OF THE INVENTION

There is known a thermal treatment method for a food product by which the product is being cooled down or (and) heated up by the means of heat-conducting surface of a heat exchanger, in which the product is being mixed. During this procedure, all the required technological process parameters should be maintained as necessary

This method is implemented in numerous types of technological equipment in the food industry. In particular, in a high-temperature dairy pasteurization plant, lactate produce tank, mixer, surge drum and super-cooler during margarine production, heat-exchanger MOM-L during confectionary fats and cooking fats production, votators and heat-exchanger devices during mayonnaise and salad dressings production.

During such processes, cold and heat are produced in separate units, whereas a coolant and a heat carrier carrying heat and cold are directed into a tube space jacket of the heat-exchanger, which has a “tube in a tube” design The product in the internal tube is being stirred by the installed inside stirrers.

However, to utilize this method, significant thermal energy is required to heat up the product as well as refrigeration energy is necessary to chill down the product, respectively.

During the cooling down process, for instance, of confectionary and cooking fats in the heat-exchanging device TOM-L, the fat temperature at the outlet, required by the technological process, should be maintained by circulation of the medium (brine) between the cylinders, into the closed circuit of the heat-exchanging device having an evaporator of the refrigerating unit. In this case, an increased consumption of the cooling power can be explained by cooling losses in the brine circuit because of the temperature differences between the temperature of the brine and the relatively low boiling temperature of the coolant in the refrigerating unit. All these facts result in the increased power consumption by the refrigerating unit.

There is a known method of cooling a fat mixture, which is implemented in apparatus having a cylindrical heat exchanger. The heat exchanger has a rotating turbolator installed inside (such as a displacing drum with knives) and an ammonia refrigerating unit having an evaporator, a condenser and a compressor. Evaporator cools down a coolant medium (brine) which circulates over external surface of the cylinder and cools down the fat mixture through its walls. [Handbook for producing and processing technology of vegetable oils and fats. Volume III. Book 2. Margarine products, mayonnaise and food mustard production. Second edition. VNIIZh. Leningrad 1977, pages 148-149, 347-353]

The present of a rotating turbolator allows one to increase significantly the intensity of heat transmission from a viscous liquid to the cylinder walls. Disadvantages of such equipment are:
Losses of refrigeration power because of thermal resistance during the heat transmission from the cylinder to the brine and from the brine to the ammonia boiled in the evaporator, as well as other losses during propagation of the brine from the evaporator to the cylinder;
Insufficient dependability of operation because of the short life time of the compressor;
Eventual ammonia pollution of the environment.

There is a known method of cooling of the margarine emulsion in an apparatus having a cylinder with turbolator installed inside the cylinder (in the form of a shaft with knives) and an ammonia refrigerating unit which includes an evaporator joined with a cylinder, a condenser and a compressor [Handbook of producing and processing technology for vegetable oils and fats. Volume III. Book 2. Margarine products, mayonnaise and food mustard production. Second Edition. VNIIZh. Leningrad. 1977 pages 89-96 (prototype)].

If the method is implemented on the described equipment, fewer losses are observed because of the decrease in heat resistance during heat transmission from margarine emulsion to ammonia and because of the decrease in refrigeration losses with the brine.

However, a portion of the cooling power is lost during heat transmission from margarine emulsion to boiling ammonia. It should be noted that there is insufficient dependability of the operating of the compressor and the probability of pollution of the environment with ammonia.

The closest known method is a margarine emulsion cooling method during its production, providing for supplying the emulsion under pressure into the heat exchanger. The walls of the heat exchanger have their internal cooling cylindrical surface. The walls of the heat exchanger exert constant mechanical pressure onto the emulsion and displace the emulsion with the help of a rotating shaft. [Fat processing technology, B. N. Tyutyunnikov, M., 1979, pages 347-353].

According to that method, cooling of the emulsion takes place in a device—a displacing cooler (votator)—under intensive stirring down to the temperature of 1-2° C. below the margarine solidification point. For this reason, the brine temperature in the coolant jacket should be maintained between −14° C. to −17° C.

The displacing cooler (votator), designed for super cooling and mechanical processing of the margarine emulsion, comprises several heat exchanging apparati connected in series, which are equipped with a coolant jacket. Internal walls of the cylinder are a cooling surface. There are tubular shafts inside cylinder rotating at the speed of 400-700 rpm, the shafts having folding scraper knives on their surface. The number of heat exchanger apparati varies from 1 to 4, depending on the capacity of the equipment. Cylinders are arranged horizontally in a row or one above another. Emulsion is supplied into the votator from a homogenizer pressurized to 2.5-3 MN/m² at 34-36° C. After passing through all the section of the votator, the emulsion leaves the vorator at the temperature 10-14° C. In the evaporation chamber the temperature of ammonia varies from −10° C. to −14° C. Cooling of the margarine emulsion is done by supplying an ammonia coolant into the evaporation chambers of votator. Stirring of the emulsion is performed by rotating the shaft of the votator. Hot water is being continuously pumped through the tubular shaft of the votator to prevent sticking of the cooled emulsion to the working parts of the tubular shaft.

The required cooling for 1 ton of margarine amounts to 138 MJ (33 000 kcal

The temperature of emulsion on the outlet of the super cooler required by the technological process is maintained by evaporating of the coolant (ammonia) directly in the jacket between two cylinders

The described method eliminates the need to have a closed circulation circuit of the coolant medium, leading to reduced refrigeration losses eliminating the expenditure of energy on pumping of the coolant medium.

However, when implementing this method for maintaining the temperature of the margarine emulsion at the outlet of the super cooling apparatus set by the technological process, it is necessary to maintain a relatively low boiling temperature of the coolant. It leads to an increase of power consumed by the refrigerating unit, which, in turn, leads to an increase in specific power consumption per unit of the produced food product.

The drawbacks of the known method also are the uneven cooling of the emulsion of the product due to creating of nucleating centers first near the cylindrical walls of the shaft. That leads to uneven solidification of the emulsion and, correspondingly, to the rotation of the shaft at a lower speed. The uneven cooling of the emulsion leads to the decrease in the productivity of the apparatus

### SUMMARY OF THE INVENTION

It is the object of the present invention to provide a method and apparatus for heat processing of an emulsion of a food during the production of the food product.

The method and apparatus of the present invention provide for decreasing power consumption spent on the thermal processing of the product.

The technical result is demonstrated by achieving even cooling of the product and the even formation of the nucleation centers at a defined rotation speed of the shaft and the speed of displacement of the product, as well as the present of thermoelectric battery disposed on the flat portions of the outer surface of the housing of the heat exchanger.

The method results in an increased productivity and dependability of the apparatus, its environmental safety and power consumption efficiency.

The method of heat processing of a food product during production comprises supplying the emulsion under pressure into a heat exchanger. The heat exchanger has a housing with walls having an inner cylindrical cooling surface exerting continuous mechanical effect on the emulsion The emulsion is displaced by a rotating shaft. The method differs from the known ones in that the speed of displacing the product is maintained within the limits of 3.45-6.89 m/sec at the rotation speed of the shaft between 750 rpm and 1440 rpm while maintaining constant temperature of the cooling inner surface of the walls by means of a thermoelectric battery. The cold junctions of the battery are disposed on the flat portions of outer surface of the housing.

Thermal power supplied to the thermoelectric battery amounts to 2.5-5.0 Wt/cm² of the heat transferring surface of the heat exchanger

The apparatus for heat processing of a food product comprises a heat exchanger and a rotatable turbolator disposed inside the heat exchanger. The heat exchanger has a housing which has an inner cylindrical cooling surface. On the outer surface of the housing, a thermo electrical battery is mounted, the battery having cold and hot junctions. The battery is mounted on the housing such that its cold junctions contact the outer surface. It is provided that the outer surface is flat at the places where the thermoelectric battery is mounted. The hot junctions of the battery are thermodynamically connected to the heat exchanger coupled with the circulation circuit of the water supply.

The apparatus can be equipped with an additional heat exchanger disposed in a flow of external air, allowing for the formation of a closed circulation circuit of a heat carrier through the heat exchanger of the thermoelectric battery via the switching devices.

### BRIEF DESCRIPTION OF THE DRAWINGS

The method is implemented in an apparatus schematically illustrated in, the drawings:

FIG. 1. is a cross-section of a heat exchanger with an installed thermoelectric battery.

FIG. 2. is a schematic illustration of hydraulic circuit operating during a warm season.

FIG. 3. is a schematic illustration of hydraulic circuit operating during a cold season.

### DETAILED DESCRIPTION OF THE PREFERRED EMBODIMENTS

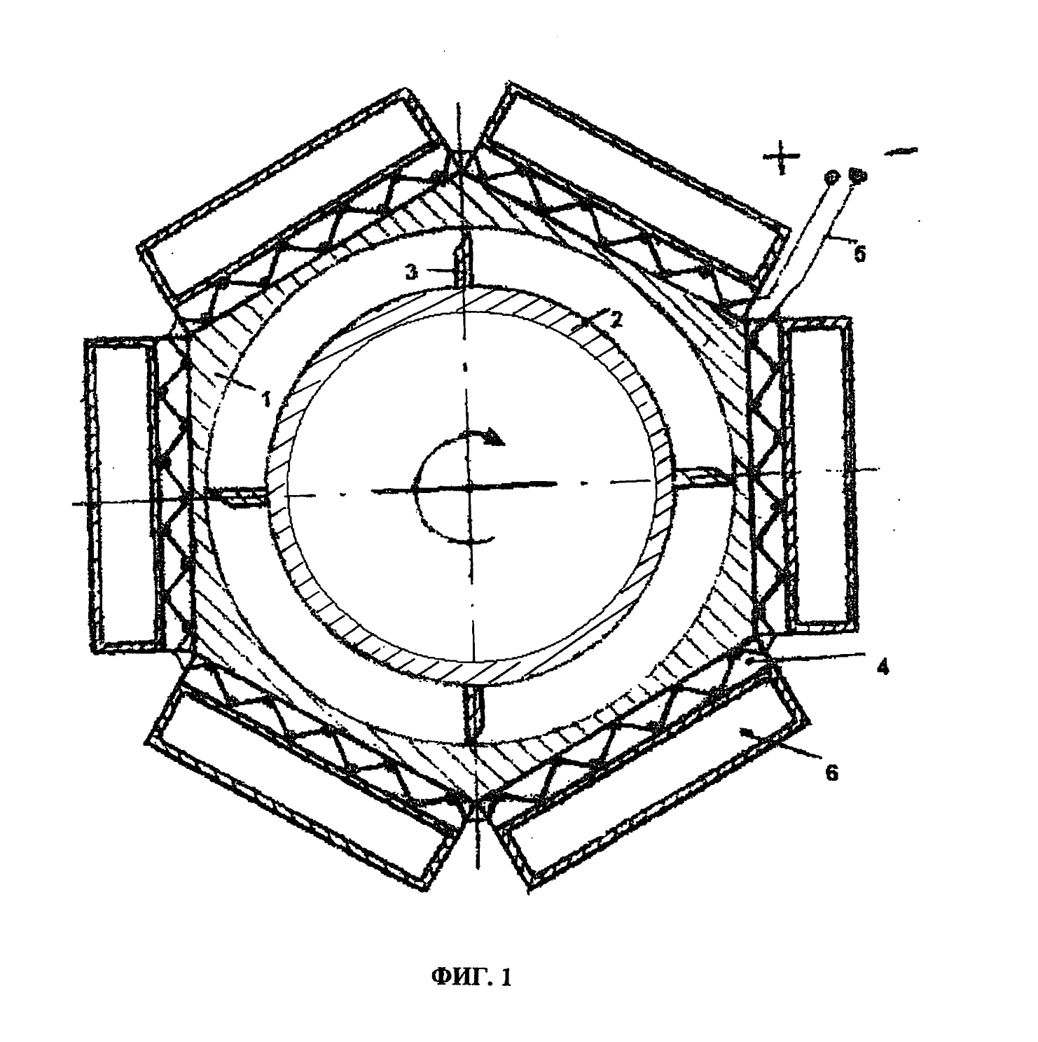

The apparatus (FIG. 1) comprises a heat exchanger with housing 1 having an inner cylindrical surface. The outer surface of housing 1 has flat portions. A rotatable shaft 2 with cutters (knives) 3 is disposed inside housing 1. The apparatus comprises a thermo electrical battery 4 coupled to direct current power supply 5. The cold junctions of the thermoelectric battery 4 are disposed on the outer surface of housing 1, and the hot junctions of the battery are connected to a heat exchanger 6.

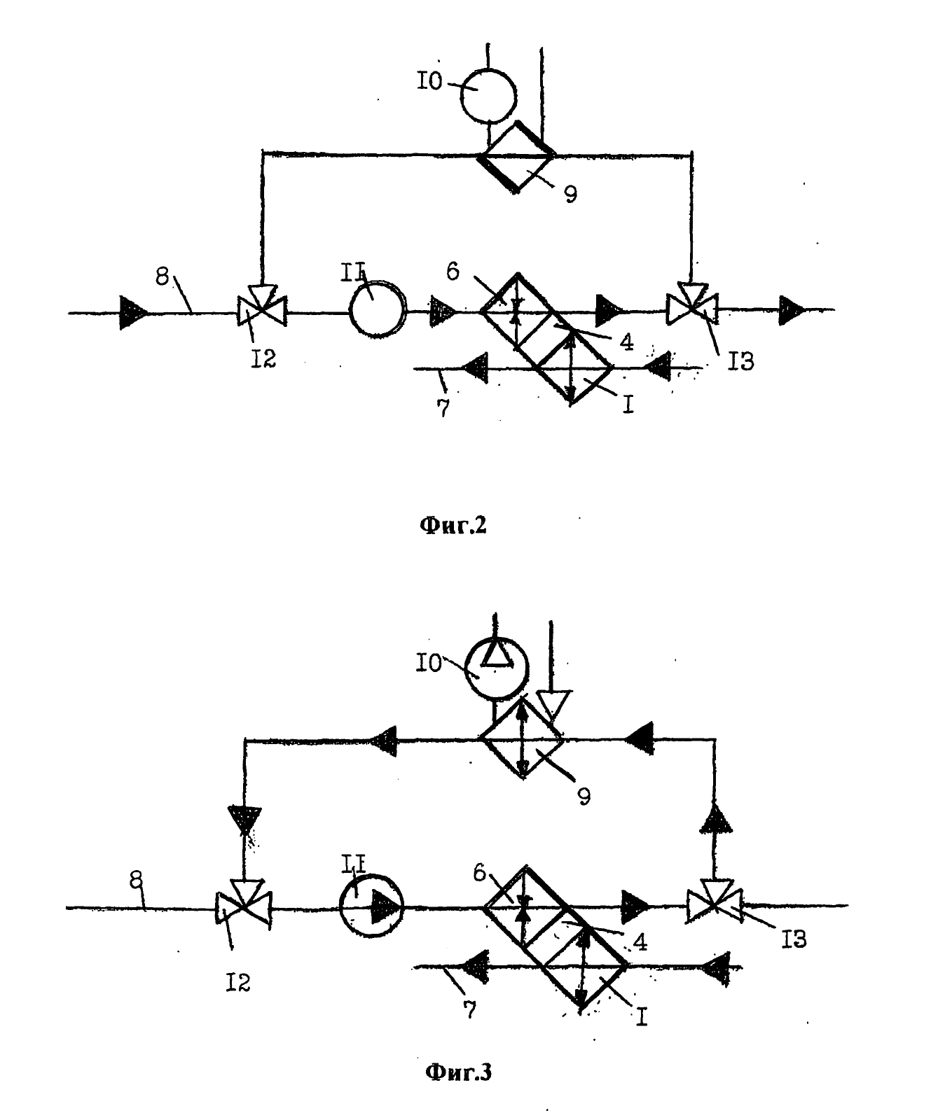

Housing (FIG. 2, 3) can be integrated in a circulating circuit 7 of the margarine mixture, and the heat exchanger 6 can be integrated into a water supply circuit 8.

During a cold season an additional heat exchanger 9 with a fan 10 is disposed in the flow of ambient air to form a closed heat carrier circuit with heat exchanger 6. The closed heat carrier circuit includes, for example, a pump 11 and three-way valves 12 and 13.

When the power is supplied from power supply 5 for operation of the apparatus in the cooling mode during the warm season, the cold junctions of thermoelectric battery 4 are located on the outer surface of housing 1, and the mixture inside the housing cools. The thermal energy and the energy of battery 4 is conducted away from the mixture via the hot junctions and heat exchanger 6 and is absorbed by tap water circulating through the heat exchanger in the water supply circulation circuit (FIG. 2).

When the temperature of ambient air during the transitional and cold season is colder than that of the tap water, heat exchanger 6, three-way valves 12, 13, a heat exchanger 9 and a pump 11 form a closed circulation circuit (FIG. 3). The thermal energy from the emulsion in housing 1 and the energy of battery 4 are conducted away into the ambient air through heat exchanger 9 by fan 10.

Because no liquid coolant and no compressor are used during refrigeration cycle, as well as because of the decrease of the power consumption by the apparatus, reliability of operation and environmental safety of the apparatus are ensured.

The heat treatment method of a food product is practiced as follows

### EXAMIPLE 1

The margarine emulsion for cooling is supplied into housing 1 of the heat exchanging apparatus having a length of 1.13 m, a radius of the inner cylindrical surface of 0.0508 m, and a shaft of a radius of 0.0405 m, for heat treatment in margarine production.

The number of cylinders connected in series—3.

The inner walls of the housing are a cooling surface. The temperature of the inner surface is maintained constant within 10° C. to ±2° C. A tubular shaft is disposed inside the housing, which shaft is rotation at the speed of 750-1440 rpm. Folding scraper knives are disposed on the surface of the shaft. The margarine emulsion is supplied to the apparatus from a homogenizer pressurized up to 2.5-3 MN/m² at the temperature of 34° C.-36° C. and is moved (displaced) by the rotating shaft at the speed of 3.45-6.89 m/sec. Such speed of the emulsion is necessary and sufficient for even cooling of the whole mass of the emulsion during its displacement.

The thermal power of 5.0 Wt/cm² is supplied from the external power source to the thermoelectric battery, which allows one to maintain constant temperature of the inner surface of the cylinder. The cooling of the margarine emulsion takes place along the whole length of the heat exchanger. The margarine emulsion is outputted from the apparatus at the temperature of 14° C.

The consumption of cooling power for 1 ton of margarine amounts to 138 MJ (33000 kcal). The production capacity of the apparatus is 2500 kg/h.

### INDUSTRIAL APPLICABILITY

The above-referenced rotation speed of the shaft, the speed of product displacement and the pressure at which the margarine emulsion is supplied into the apparatus provide for a more frequent contact of a unit volume of the product with the inner cooling wall, even formation of nucleation centers and small crystals.

Utilization of this invention allows to decrease (compared to its prototype) power consumption on average by 47.7%

Table 1 shows the data on the power savings depending on the rotation speed of the shaft and the displacement of food product inside the device.

| | | Supply of food | |
|---|---|---|---|
| | Speed of displace- | product to be | |
| Rotation speed of | ment of food product, | heat treated, G, | Power |
| the shaft, rpm | m/sec | kg/sec | saving, % |
| 720 | 3.45 | 0.879 | 35.8 |
| 960 | 4.60 | 0.919 | 45.0 |
| 1200 | 5.75 | 1.073 | 50.1 |
| 1440 | 6.89 | 1.140 | 50.7 |
| 500 | 2.41 | 0.733 | 0 |

What is claimed is:

1. A method of heat treating an emulsion of a food product during production of the food product, the method comprising:
supplying the emulsion of the food product under pressure into a heat exchanging apparatus comprising a housing with an inner cooling cylindrical surface and an outer surface, and a rotating shaft rotating inside the housing at a rotation speed. between 750 rpm and 1440 rpm;
exerting mechanical action on the emulsion by the rotating shaft and displacing the emulsion inside the housing;
maintaining a speed of displacement of the emulsion within the limits from 3.45 m/s to 6.89 m/s; and
maintaining a constant temperature of the inner cooling cylindrical surface by coupling cold junctions of a thermoelectric battery to the outer surface of the housing.

2. The method of claim 1, wherein the outer surface has a flat shape at a location of the thermoelectric battery.

3. The method of claim 1, wherein the thermoelectric battery is coupled to an external power source supplying thermal power of 2.5 Wt/cm² to 5.0 Wt/cm 2 to the battery.

4. An apparatus for heat treatment of a food product comprising:
a heat exchanger having a housing, the housing having an outer surface and an inner cooling cylindrical surface; and
a thermoelectric battery disposed on the outer surface, the thermoelectric battery having cold and hot junctions, the cold junctions of the battery being coupled to the outer surface, the hot junctions of the battery being thermodynamically coupled into a water circulation circuit of the heat exchanger.

5. The apparatus of claim 4, wherein the outer surface has a flat shape at a location where the thermoelectric battery is disposed.

6. The apparatus of claim 5, further comprising an additional heat exchanger disposed in a flow of ambient air and forming a closed heat carrier circuit with the heat exchanger of the thermoelectric battery via switching devices.
